(19) United States
(12) Patent Application Publication
(10) Pub. No.: US 2022/0285794 A1
(43) Pub. Date: Sep. 8, 2022

(54) METHOD FOR CONTACTING THE BATTERY CELLS OF A BATTERY MODULE, AND BATTERY EXTINGUISHING DEVICE THEREFOR

(71) Applicant: Rheinisch-Westfaelische Technische Hochschule (RWTH) Aachen, Aachen (DE)

(72) Inventors: Falko FIEDLER, Aachen (DE); Georg BERGWEILER, Aachen (DE); Soeren BETHLEHEM, Aachen (DE)

(21) Appl. No.: 17/633,425

(22) PCT Filed: Sep. 17, 2020
(86) PCT No.: PCT/EP2020/075942

§ 371 Date: Feb. 7, 2022

(30) Foreign Application Priority Data
Oct. 10, 2019 (DE) 10 2019 127 314.5

(51) Int. Cl. H01M 50/516; A62C 3/16; A62C 35/13; H01M 10/6567; H01M 50/204

(52) U.S. Cl. CPC H01M 50/516; A62C 3/16; A62C 35/13; H01M 10/6567; H01M 50/204; H01M 2200/00

(57) ABSTRACT

In a method and apparatus for contacting battery cells of a battery module by welding, module of at least two battery cells is inserted into a battery module holder, whereupon electrical connectors of the at least two battery cells are welded together. The battery module holder is in a battery extinguishing container that is open toward the top for access by a welding device and is connected via at least one extinguishing agent line to a liquid extinguishing agent reservoir for transfer of the liquid extinguishing agent from the reservoir into the battery extinguishing container.

The invention relates to a method for contacting the battery cells of a battery module by welding, and in particular laser welding, in which a battery module comprising at least two battery cells to be connected to one another is inserted into a battery module holder, whereupon the electrical connectors of the at least two battery cells are welded to one another. The invention also relates to a battery extinguishing device comprising a battery extinguishing container.

It is generally known in the prior art to connect the electrical connectors of battery cells of a battery module, which comprises at least two battery cells, to one another by welding, for example to achieve a series connection and/or parallel connection between the battery cells, depending on what is needed. The connectors are typically connected by way of locally delimited weld joints, and in particular spot or line weld joints, which can be carried out both by resistance, arc or ultrasonic welding and, preferably in a contactless manner, by laser welding. It is known, for example, to direct, and in particular to focus, a laser beam by way of a robotic welding arm on the regions of the electrical connectors to be connected, which are preferably disposed on top of one another.

It is known that, due to excessively high energy input into the connectors or onto the battery cell itself, or due to faulty battery cells, heat generated during welding can cause the materials in a battery cell to burn. For example, lithium compounds are prone to catch fire. This can cause a battery cell to burn away completely and can also ignite other adjoining battery cells of the battery module. The effect of ignition due to overheating is also referred to as thermal runaway. In the process, battery cell material may leak from the battery cells and be hazardous to the environment and persons involved in the production process.

It is thus also known in the prior art to provide a battery extinguishing device in the event of a fire of a battery cell.

Document CN108553773 describes a battery extinguishing device comprising a battery extinguishing container for extinguishing the battery of a motor vehicle. According to the teaching of this document, the battery extinguishing container is filled with saline water and is thus available and ready for use in the event that extinguishing is needed. The battery cells of a battery module are welded together outside the battery extinguishing container, and if a fire occurs, the battery module has to be transferred from a raised position into a lowered position by way of a lifting device and immersed in the saline water of the battery extinguishing container. This extinguishes the fire, and the battery is discharged by way of the saline water.

The problem is that the battery extinguishing container has to be made available after being filled. As a result, the container is heavy, not protected against liquid spilling over during movement, and thus not mobile, or only mobile to a limited extent. In addition, the battery module, which can weigh several hundred kilograms, has to be moved in the event of a fire. Such a battery module is cumbersome and dangerous to move, and according to the teaching of this document, a hydraulic lifting device thus has to be provided which, in the document, is described as being actuated by way of a foot-operated pump in the event of a fire. Raising the battery is thus a labor-intensive and tedious process, and lowering the battery in the event of a fire is achieved by reducing the pressure in the hydraulic system, which may take too long. In addition, the water in the battery extinguishing container would be displaced too quickly and expelled therefrom if the battery were lowered too rapidly into the filled battery extinguishing container.

It is therefore an object of the invention to provide a method for contacting the battery cells of a battery module which requires less effort and in which, in particular, the transport of a battery that has already caught fire is avoided. Moreover, the battery extinguishing device, or at least the battery extinguishing container thereof, is to have enhanced mobility compared to the prior art described. Preferably, the method allows for shorter extinguishing times. It is also an object of the invention to provide an improved battery extinguishing device, which preferably also achieves the aforementioned object.

This object is achieved by a method of the type in question mentioned at the outset, in which the battery module holder is disposed in a battery extinguishing container that is open toward the top, which is connected via at least one extinguishing agent line to a reservoir comprising liquid extinguishing agent, which can be transferred from the reservoir into the battery extinguishing container, wherein, prior to welding, the battery module is disposed beneath the upper opening edge of the battery extinguishing container as a result of being inserted into the battery module holder, whereupon the electrical connectors are welded together by way of a welding device, and in particular by way of a welding robot, through the upper opening of the battery extinguishing container.

The object is furthermore achieved by a battery extinguishing device comprising a battery extinguishing container, a battery module holder, disposed in the battery extinguishing container, for receiving a battery module comprising battery cells to be welded together, and furthermore comprising a reservoir that can be filled with liquid extinguishing agent, wherein the reservoir is connected to the battery extinguishing container by way of at least one extinguishing agent line through which liquid extinguishing agent can be transferred into the battery extinguishing container.

An essential core idea of the invention is to provide a battery extinguishing container, which, even though this can be filled with a liquid extinguishing agent, for example with an extinguishing agent containing water, is not filled with the liquid extinguishing agent until an actual fire occurs.

In contrast to the prior art cited at the outset, the battery extinguishing container is thus empty of the extinguishing agent. This alone allows the battery extinguishing container to be transported more easily than in the prior art, and consequently to be transported better. The invention thus allows for greater mobility of the battery extinguishing device, or at least of the battery extinguishing container thereof. However, the invention is not limited to the battery extinguishing container being mobile, but may also be used in a stationary manner according to the invention.

Instead of filling the battery extinguishing container with the liquid extinguishing agent from the outset, the invention provides for storing the extinguishing agent in a reservoir that is separate from the battery extinguishing container, from which the liquid extinguishing agent can be transferred into the battery extinguishing container in the event of a fire, for which purpose the reservoir and the battery extinguishing container are connected to at least one extinguishing agent line through which the extinguishing agent can flow.

Another key advantage compared to the aforementioned prior art is that, in the case of the invention, the battery module is already disposed in the battery extinguishing container for the purpose of being welded. A battery module that has caught fire therefore does not first have to be transported into the battery extinguishing container in the event of a fire, as is the case in the prior art. Transport, which is already fraught with risk, especially when a battery module is burning, is thus avoided according to the invention. In the invention, the battery module present battery module which is already situated in the battery extinguishing container beneath the upper opening edge thereof is welded. For this purpose, the end of an arm, when a welding robot is employed, or at least the directed laser beam, in the case of laser welding, can enter from above through the opening of the battery extinguishing container into the volume thereof.

So as to be able to dispose the battery module in the battery extinguishing container, the battery module is attached in a battery module holder, which is already situated in the battery extinguishing container, for example, or which is inserted into the battery extinguishing container together with the battery module.

The battery module holder can be designed as a welding bench, for example, which carries a module holding frame, in particular indirectly by way of supports, wherein the welding bench is attached in the interior of the battery extinguishing container, and in particular at the bottom of the battery extinguishing container. A battery module can be inserted into the module holding frame and be attached therein by way of clamping or bracing, so that the battery module is locally fixed for the welding process.

One embodiment can provide that multiple battery modules at a time can be received in the module holding frame of the battery extinguishing device, for example the one mentioned above, which is disposed at the welding bench, wherein one battery module to be presently welded, from among the multiple battery modules, can be brought into a working position, by way of translation and/or rotation of the module holding frame, in which only the battery module to be welded is disposed beneath the edge of the battery extinguishing container in a region that can be flooded with the extinguishing agent. Such a module holding frame can be designed in the manner of a revolver. If a fire occurs on the presently welded battery module, only this battery module is subjected to extinguishing agent, while the remaining modules that have already been welded or not yet welded are not subjected to the extinguishing agent, and these, in particular, preferably do not make contact with extinguishing agent at all. For example, these other battery modules could be disposed in a region of the module holding frame shielded from extinguishing agent.

The welding bench can, for example, be made of a metallic, and preferably hollow, plate having a predetermined thickness, the plate surface of which is provided with holes. Such a perforated design can also be provided on supports which are possibly used. In this preferred embodiment, the module holding frame is, in turn, attached, and preferably detachably attached, to the welding bench, for example by way of the supports, so that a battery module that has already been inserted into the module holding frame can be inserted, together with the module holding frame, into the battery extinguishing container and removed therefrom. The invention can also provide for the module holding frame to be fixedly disposed in the battery extinguishing container.

According to the invention, the battery extinguishing container is open toward the top and surrounds an inner volume that can be at least partially filled with the extinguishing agent. Apart from the upper opening, the battery extinguishing container is tight with respect to the added extinguishing agent so that extinguishing agent that is added to the container in the event of a fire cannot escape therefrom, or at the most can escape through the upper opening. A drain opening can preferably be provided in the wall of the battery extinguishing container. The upper edge of the opening of the battery extinguishing container can preferably be located in a horizontal plane, but this is not absolutely necessary.

In a preferred embodiment, the battery extinguishing container can comprise a base plate, preferably a polygonal, and more preferably a quadrangular, base plate, to which upright, and preferably vertical, walls are tightly attached, the number of which corresponds to the number of corners. In one possible embodiment, the material of the base plate and of the walls can be acid-resistant or, if this is not the case, comprise an acid-resistant coating. The base plate and walls can be connected by welding, in particular in the case of a metallic design of these elements. The battery extinguishing container can generally also be made of a non-metallic material, such as a plastic material.

It is essential for the invention that a battery module inserted into the battery extinguishing container is disposed with the highest point thereof below the upper edge, at least below the lowest point of the upper edge of the battery extinguishing container so that extinguishing agent added in the event of a fire can reach a level that is located above the highest point of the battery module.

In this way, it is ensured that, in the event of a fire, the entire battery module is completely covered by extinguishing agent, or that the battery module is completely immersed therein.

The method according to the invention thus provides for the welding of the battery cells of a battery module to be carried out in the battery extinguishing container of the battery extinguishing device according to the invention, wherein it shall be assumed at least routinely for the method that a fire will not occur. Nonetheless, the method and the device provide safety in the event of such a potential fire.

In a preferred refinement of the method, the invention provides that the battery extinguishing container is flooded with the extinguishing liquid from the reservoir if a fire occurs, so that the battery module is wetted by the extinguishing liquid and thereby cooled. Open fire is extinguished directly, and the cooling causes a drop below the ignition temperature of the materials in the battery cells, whereby further combustion is suppressed. Material that may be leaking from the battery cells can be bound in the extinguishing agent, for example also by way of a treatment agent provided for this purpose in the extinguishing agent, which may be tailored to the materials of the battery cells in the individual case. The treatment agent can already be present in the extinguishing agent when this is stored in the reservoir.

The invention can also provide that a ready-to-use amount of a treatment agent is present in the interior of the battery extinguishing container, which can be mixed with extinguishing agent added to the battery extinguishing container, and preferably mixes therewith automatically when the extinguishing agent is transferred into the battery extinguishing container.

It is also possible for a flue gas venting device, or at least openings through which flue gas can be vented, to be disposed in the battery extinguishing container, for example in the upper edge thereof.

The invention preferably provides that the battery extinguishing container is filled with the extinguishing agent up to a fill level that is above the battery module. The amount of extinguishing agent stored in the reservoir is preferably tailored to the volume of the battery extinguishing container to be filled or, alternatively, the volume of the battery extinguishing container to be filled is tailored to the amount of extinguishing agent to be stored, in such a way that the extinguishing agent level, after the battery extinguishing container has been completely filled with the stored amount of extinguishing agent, is located above the battery module, preferably at least 100 mm, more preferably at least 150 mm above the highest point of the battery module.

This ensures that the battery module is sufficiently covered by extinguishing agent, so as to sufficiently cool even the regions of the battery module or of the battery cells which are located at the top, and in particular against the background that heated extinguishing agent accumulates at the top.

In principle, the invention can provide that the liquid extinguishing agent stored in the reservoir is transferred in any arbitrary manner into the battery extinguishing container in the event of a fire.

For example, it may be provided that a pump is assigned to the at least one extinguishing agent line, by way of which the extinguishing agent can be pumped from the reservoir through the extinguishing agent line into the battery extinguishing container.

A particularly preferred embodiment of the invention, in contrast, provides that the reservoir is disposed above the battery extinguishing container, and the liquid extinguishing agent is transferred from the reservoir through the at least one extinguishing agent line into the battery extinguishing container exclusively by way of gravity.

The reservoir is preferably arranged above the battery extinguishing container, laterally offset therefrom, whereby accessibility of the battery module through the upper opening thereof is facilitated. The bottom of the reservoirs is preferably at least disposed at a higher level than the upper opening edge. The distance between the bottom of the reservoir and the upper opening edge of the battery extinguishing container is preferably greater than 50% of the height of the battery extinguishing container.

Filling the battery extinguishing container with the extinguishing agent from the reservoir purely by the action of gravity has the advantage that the action of gravity cannot fail, which may be the case with pumps.

The invention can preferably provide that the extinguishing agent is introduced into the battery extinguishing container through the at least one extinguishing agent line below the battery module, and that the container fills with extinguishing agent from the bottom to the top. As soon as the extinguishing agent reaches a level in the container that is above the opening of the extinguishing agent line, the extinguishing agent is further supplied below the rising extinguishing agent level formed in the battery extinguishing container. In this way, particularly smooth, low-splash filling of the battery extinguishing container is achieved.

The invention can provide for this purpose that the at least one extinguishing agent line leads into the battery extinguishing container close to the bottom of the battery extinguishing container, and in particular below the module attachment plane of the battery module holder, or below the attached battery module, and in particular from the lowest point thereof. The module attachment plane is, for example, the plane on which the battery module rests in a module holder.

The invention can furthermore provide that at least one displacement body is disposed in the battery extinguishing container. Such a displacement body, which can, for example, be designed as a hollow body, takes up volume in the battery extinguishing container, which does not have to be taken up by the extinguishing agent in the event of a fire. In this way, the battery extinguishing container can be filled using less extinguishing agent, which also increases the speed with which filling is achieved. In this way, the aforementioned adaptation of the volume of the battery extinguishing container to be filled to the stored extinguishing agent volume can be achieved.

Multiple displacement bodies can at least partially surround a battery module. A respective displacement body can be attached, for example at the bottom, to the bottom region of the battery extinguishing container, for example to the welding bench of the battery module holder, in particular to prevent floating.

The invention preferably provides that an activatable valve, and in particular a flap valve or a sliding valve, is provided in the extinguishing agent line, which is opened in the event of a fire. As a result of the valve being opened, the extinguishing agent can be transferred into the battery extinguishing container, preferably when the transfer is purely gravity-based. The opening of a respective valve can be effectuated, for example, by a manually actuatable trigger element, for example an emergency button. The trigger element can be actuated by a person, for example, who notices a fire. The trigger element can, however, also be a fire detector, which, for example, establishes that a defined limit temperature at the battery cell or at the connector thereof has been exceeded. The trigger element can also be a pressure detector, which detects when a limit pressure in the interior of the battery cells is exceeded and thereafter activates a valve.

For example, the valve can be disposed close to the reservoir, for example beneath the bottom thereof. It may also be provided that the valve is disposed close to the battery extinguishing container. Close to the extinguishing container shall be understood to mean that this is situated closer to the battery extinguishing container than to the reservoir. In this way, it is achieved that a significant, and in particular a predominant, length of the overall length of the extinguishing agent line is already filled with extinguishing agent free from air. This results in an extinguishing agent column, which is at least partially free from air up to the battery extinguishing container in the extinguishing agent line and which results in maximum possible acceleration of the extinguishing agent when the valve is opened. Compared to an arrangement of the valve close to the bottom of the reservoir, the extinguishing agent thus enters the battery extinguishing container more quickly in the event of a fire.

In particular during the intended filling by way of gravity action, the invention can provide for dividing the overall volume flow of the extinguishing agent flowing during the filling process among multiple extinguishing agent lines that extend between the reservoir and the battery extinguishing container. Preferably, at least two extinguishing agent lines, more preferably at least three, still more preferably at least four, and still more preferably at least five extinguishing agent lines are used. Each of the lines can thus, for example, be limited to a conventional manageable and commercially easily available line cross-section. A dedicated valve can be assigned to each of multiple extinguishing agent lines, wherein all valves are preferably opened by a shared trigger element.

For example, the cross-sectional surface of the at least one extinguishing agent line, and in particular the overall cross-sectional surface of all extinguishing agent lines at any location between the opening out of the reservoir into the at least one extinguishing agent line and out of the at least one extinguishing agent line into the battery extinguishing line can be at least 250 cm², and preferably at least 350 cm². In this way, particularly rapid filling is achieved, in particular under the action of gravity.

In another preferred embodiment, the at least one extinguishing agent line can be designed to be flexible, for example, designed as a hose, and can be detachably attachable to the battery extinguishing container at a connecting flange. For example, the connecting flange can comprise a valve, preferably a flap valve or a sliding valve, or the valve is disposed directly upstream from the flange in the flow direction.

The connecting flange of the at least one extinguishing agent line can, for example, be disposed close to the bottom of the battery extinguishing container, and in particular below the module attachment plane of the battery module holder, or below the inserted battery module in/at the wall of the battery extinguishing container.

There is also the option of disposing the connecting flange close to the upper opening edge of the battery extinguishing container, and in particular above the opening edge thereof or at least above the maximum intended fill level of the battery extinguishing container.

The connecting flange is preferably connected via a line to the battery extinguishing container, which leads into the battery extinguishing container close to the bottom of the battery extinguishing container, and in particular below the module attachment plane of the battery module holder, so that the battery extinguishing container is also filled from beneath by way of the upper flange arrangement.

The upper arrangement of the flange has the advantage that, after the battery extinguishing container has been filled with the extinguishing agent, the at least one extinguishing agent line can be detached from the particular connecting flange, without the extinguishing agent being able to leak from the battery extinguishing container. The filled container can thus be transported more easily.

According to another preferred embodiment, it can be provided that the battery extinguishing container comprises a bottom beneath which the tines of a forklift truck or a transport pallet truck can slide and/or that multiple lifting eyes are disposed on the battery extinguishing container, and in particular on the battery module holder connected to the battery extinguishing container, and preferably on the welding bench.

In this way, the battery extinguishing container can be transported more easily when empty, or after having been filled, for example out of a laser welding cell.

The invention can also provide that multiple battery extinguishing containers are assigned to one reservoir, which in particular are all simultaneously connected to the reservoir via at least one extinguishing agent line, or which can alternately be connected to the reservoir via the at least one extinguishing agent line.

During production of battery modules, in particular on a production line, a battery extinguishing container that is filled in the event of a fire can thus be replaced quickly with a new, empty container, so that production is hardly interrupted.

The invention can also provide that, in the event of a fire, in addition to flooding the battery extinguishing container, a welding arm of a welding robot is moved into a safe position, in particular in which this can no longer be contaminated by extinguishing agent or flue gases.

Exemplary embodiments will be described based on the drawings.

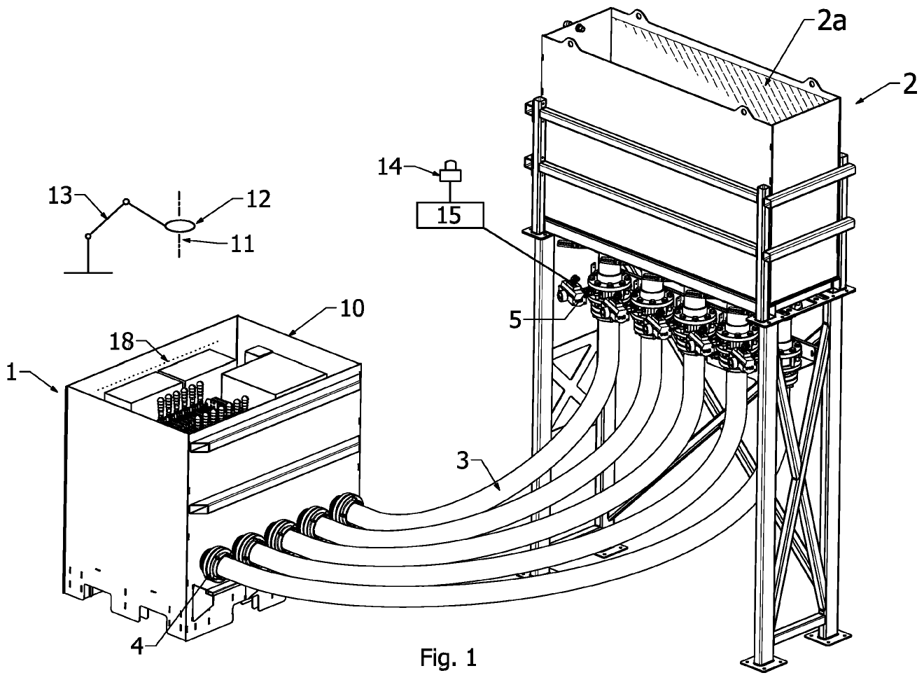

FIG. 1 shows, in an overview, a battery extinguishing device of the type according to the invention, comprising a battery extinguishing container 1 and a reservoir 2 for extinguishing agent. In order to weld the battery cells together, a battery module is disposed in the unfilled battery extinguishing container 1 or in the battery module holder thereof. Liquid extinguishing agent is stored in the reservoir 2 for the event in which a fire arises.

Here, the reservoir 2 is connected to the battery extinguishing container 1 by way of multiple extinguishing agent lines 3. Each extinguishing agent line 3 leads into the battery extinguishing container 1 via a connecting flange 4 below the battery module, and into the bottom of the reservoir 1 via a dedicated valve 5. The reservoir 2 is disposed above the battery extinguishing container 1 and, here, preferably laterally offset therefrom, so that the extinguishing agent 2a flows on its own into the battery extinguishing container 1 due to the action of gravity, here, from the bottom, after a respective valve 5 has been opened. The volume of the battery extinguishing container 1 to be filled and the amount of extinguishing agent 2a are tailored to one another so that, after the extinguishing agent 2a has completely flowed into the battery extinguishing container 1, the extinguishing agent 2a is at a fill level 18 that is above the highest point of the battery module 6, and preferably at least 100 mm thereabove.

For welding, the laser beam 11 can pass through ab outcoupling lens 12 of an indicated robotic arm 13 from above, through the opening, enclosed by the opening edge 10, into the interior of the battery extinguishing container 1 and carry out the welding.

In the event of a fire, each of the valves 5 can be opened by way of a trigger element 14, which acts on an activation device 15, for example. For this purpose, the activation device 15 transmits a control signal to the valves 5, for example. The trigger element 14 can be manually actuated and, for example, to this end, is preferably designed as an emergency push-button.

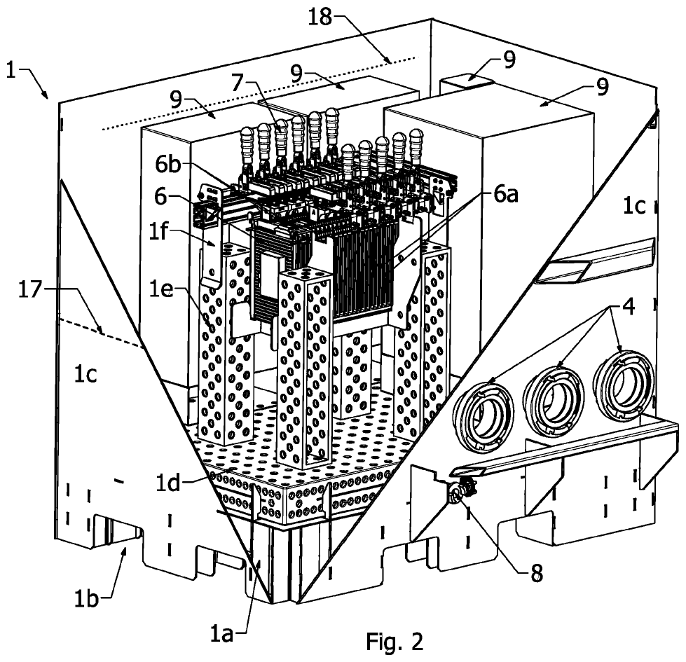

FIG. 2 shows a battery extinguishing container 1, for example that of FIG. 1, in a partially cutaway view. It is apparent here that tines of a forklift truck or pallet truck can slide beneath the bottom 1a through recesses 1b in the bottom 1a and in the side walls 1c, so that the battery extinguishing container 1 can be easily transported.

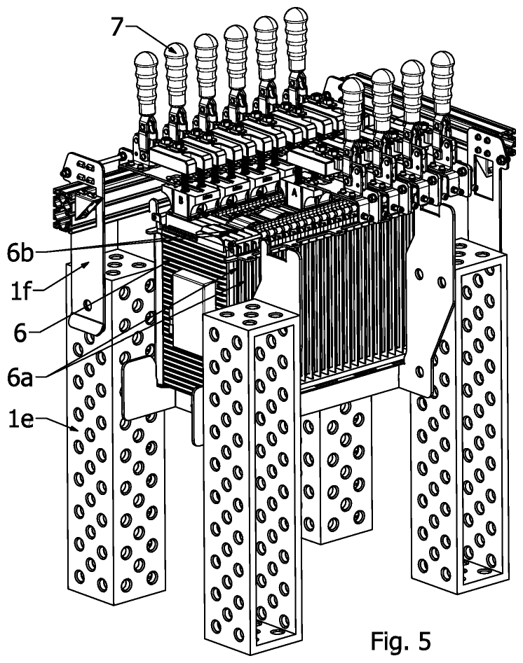

A welding bench 1d, which carries a module holding frame 1f by way of supports 1e, is attached to the bottom 1a on the inside of the battery extinguishing container 1. The battery module holder is thus formed of the welding bench 1d, supports 1e and the module holding frame 1f here. A battery module 6 comprising multiple battery cells 6a indicated by dotted lines is disposed in the holding frame 1f, the electrical connectors 6b of which are to be connected by welding. Using clamping levers 7, the connectors 6b of the battery cells 6a to be connected are pressed onto one another. The arrangement of the holding frame 1f on the supports 1e including the battery module 6, the battery cells 6a present therein, and the connectors 6b thereof is shown in FIG. 5 in an enlarged illustration, as compared to FIG. 2. The holding frame if can preferably be placed in a guided manner from above onto the supports 1e.

FIG. 2 furthermore shows a drain opening 8 in the front side wall 1c here, allowing the extinguishing agent 2a to drain from the battery extinguishing container 1 again after use. Furthermore, multiple displacement bodies 9 are disposed in the interior of the battery extinguishing container 1 which, here, can be attached to the welding bench 1d, by way of which the volume of the battery extinguishing container 1 to be filled can be reduced. These surround the battery module 6 at least partially.

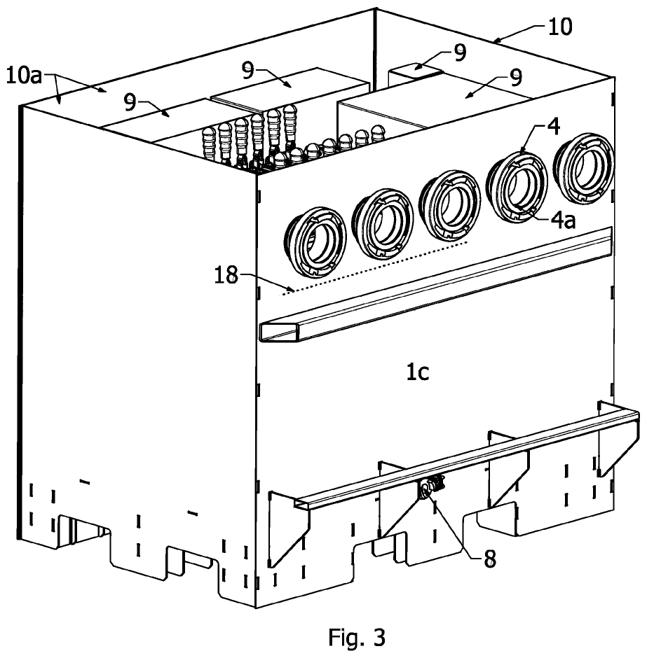

FIG. 3 shows an alternative design of the battery extinguishing container 1, which can be operated by way of the same reservoir 2 of FIG. 1.

Here, the connecting flanges 4 are disposed close to the upper opening edge 10. At this position, the flanges 4 can lead directly through the side wall 1c into the container 1, as shown, or further piping can be provided on the inside, by way of which the inflowing extinguishing agent is conducted downwardly and first flows into the battery extinguishing container 1 below the battery module. The connecting flanges 4 can be situated below the intended fill level, provided the lines 3 at the flanges 4 remain connected after the battery extinguishing container has been filled. The flanges 4 can preferably be positioned such that the lower edges 4a thereof are situated above the fill level 18 of the extinguishing agent. In this case, the lines 3 can thus be disconnected from the battery extinguishing container 1 after the same has been filled, without extinguishing agent 2a leaking.

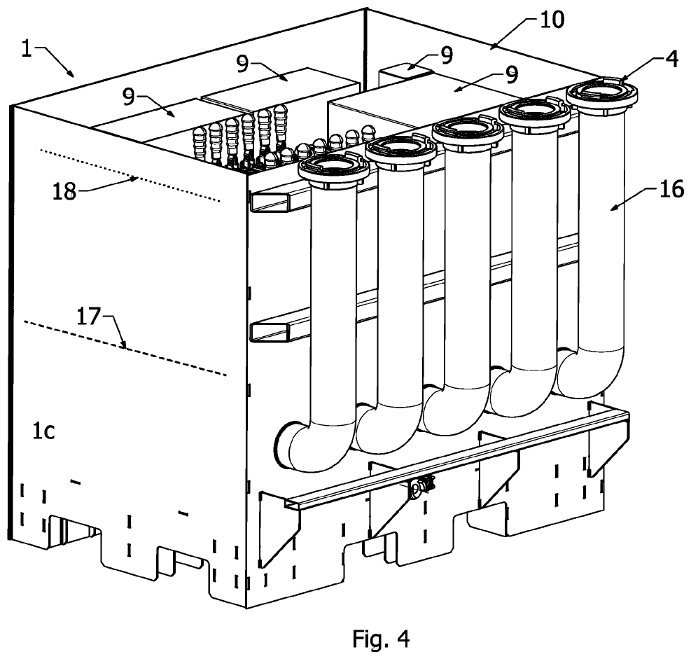

FIG. 4 shows another possible embodiment, which can likewise be operated by way of the same reservoir 2 of FIG. 1, in which the opening planes of the flanges 4, which here are preferably horizontally oriented, are likewise situated at least above the intended fill level 18 of the extinguishing agent 2a, in particular, in the illustration here, are even disposed at a level that is above the height of the opening edge 10 of the battery extinguishing container. The intended fill level 18 of the extinguishing agent can, for example, coincide with the upper surface of the displacement bodies 9. Here, the flanges 4 are, in each case, connected to a line 16 located outside the battery extinguishing container 1, which leads into the battery extinguishing container 1 below the height 17 of the module attachment plane of the battery module holder, which is indicated with dotted lines, and thus at a level below the lowest point of a battery module 6. In this embodiment as well, the lines 3 can thus be disconnected from the battery extinguishing container 1 after the same has been filled, without extinguishing agent leaking.

As mentioned above, FIG. 5 shows an enlarged detailed illustration of the holding frame if disposed on the supports 1e, including the battery module 6, the battery cells 6a and the connectors 6b.

Wherever the described figures show multiple flanges 4 and/or lines 3/16, the invention can also be designed with fewer or more than the number shown, and in particular even with only one line 3 or 16 or one flange 4.

1. A method for contacting the battery cells of a battery module by welding, comprising inserting into a battery module holder a battery module comprising at least two battery cells configured to be connected to one another and then welding together electrical connectors of the at least two battery cells, wherein the battery module holder is disposed in a battery extinguishing container that has an opening toward a top thereof, the battery extinguishing container is connected via at least one liquid extinguishing agent line to a reservoir containing liquid extinguishing agent, the reservoir and the at least one liquid extinguishing agent line being configured to transfer the liquid extinguishing agent from the reservoir into the battery extinguishing container, prior to the welding the battery module being disposed beneath an upper edge of the opening of the battery extinguishing container as a result of being inserted into the battery module holder, whereupon the electrical connectors are welded together by way of a welding device through the opening of the battery extinguishing container.

2. The method according to claim 1, wherein, if a tire occurs, the battery extinguishing container is flooded with the liquid extinguishing agent from the reservoir up to a fill level above the battery module.

3. The method according to claim 1, wherein the reservoir is disposed above and laterally offset from the battery extinguishing container, and the liquid extinguishing agent is transferred exclusively by way of gravity from the reservoir through the at least one liquid extinguishing agent line into the battery extinguishing container.

4. The method according to claim 2, wherein the liquid extinguishing agent is introduced into the battery extinguishing container through the at least one liquid extinguishing agent line which is below the battery module and configured to fill the container from the bottom to the top with the liquid extinguishing agent while predominantly supplying the liquid extinguishing agent below a rising liquid extinguishing agent level formed in the battery extinguishing container.

5. The method according to claim 1, wherein a plurality of displacement bodies are disposed in the battery extinguishing container so as to at least partially surround the battery module.

6. A battery extinguishing device comprising a battery extinguishing container, a battery module holder disposed in the battery extinguishing container and configured to receive a battery module comprising battery cells configured to be welded together, and the battery extinguishing device further comprising a reservoir configured to be filled with liquid extinguishing agent, the reservoir being connected to the battery extinguishing container by way of at least one liquid extinguishing agent line configured to transfer the liquid extinguishing agent into the battery extinguishing container.

7. The battery extinguishing device according to claim 6, further comprising a pump configured to pump the liquid extinguishing agent from the reservoir through the at least one liquid extinguishing agent line into the battery extinguishing container.

8. The battery extinguishing device according to claim 6, wherein the reservoir is disposed above and laterally offset from the battery extinguishing container, and the reservoir is configured to transfer the liquid extinguishing agent into the battery extinguishing container exclusively by the action of gravity.

9. The battery extinguishing device according to claim 6, further comprising a respective valve in each of the at least one liquid extinguishing agent line proximate the reservoir or proximate the battery extinguishing container, each of the respective valves being configured so that opening thereof effects transfer of the liquid extinguishing agent into the battery extinguishing container.

10. The battery extinguishing device according claim 6, wherein the at least one liquid extinguishing agent line leads into the battery extinguishing container proximate a bottom of the battery extinguishing container and a horizontal, plane at which the battery module is attached to the battery module holder or below the attached battery module.

11. The battery extinguishing device according to claim 6, wherein, the at least one liquid extinguishing agent line is flexible and the battery extinguishing device further comprises at least one connecting flange to each of which a respective one of the at least one liquid extinguishing line is detachably attachable, and each of the connecting flanges comprises a valve.

12. The battery extinguishing device according to claim 11, wherein each of the connecting flanges:
a. is disposed proximate a bottom of the battery extinguishing container and below a horizontal plane at which the battery module is attached to the battery module holder; or
b. is disposed above an upper edge of an opening toward a top of the battery extinguishing container or above a maximum intended fill level of the battery extinguishing container, each of the connecting flanges being connected to the battery extinguishing container via a respective line which leads into the battery extinguishing container proximate a bottom of the battery extinguishing container and below the horizontal plane at which the battery module is attached to the battery module holder.

13. The battery extinguishing device according to claim 6, further comprising at least one displacement body which is detachably attached in the battery extinguishing container and configured to reduce the volume thereof to be filled with the liquid extinguishing agent.

14. The battery extinguishing device according claim 6, wherein the battery module holder is configured as a welding bench which carries a battery module holding frame by way of supports, the welding bench being attached to a bottom of the battery extinguishing container.

15. The battery extinguishing device according to claim 14, wherein the battery module holding frame is configured to receive a plurality of the battery modules, the battery module holding frame being configured to bring the battery module to be welded into a working position, by way of translation and/or rotation of the module holding frame, and only the battery module to be welded is disposed below an upper edge of an opening toward a top of the battery extinguishing container and in a region of the battery extinguishing container configured to be flooded with the liquid extinguishing agent.

16. The battery extinguishing device according to claim 6, wherein a predetermined amount of a treatment agent is situated in an interior of the battery extinguishing container, the treatment agent being mixable with the liquid extinguishing agent added to the battery extinguishing container.

17. The battery extinguishing device according to claim 6, wherein a radial interior cross-sectional area of each of the at least one liquid extinguishing agent line throughout an entire length thereof is at least 250 cm².

18. The battery extinguishing device according to claim 6, wherein the battery extinguishing container comprises a bottom configured to slidingly receive thereunder tines of a forklift truck.

19. The battery extinguishing device according to claim 14, wherein a plurality of lifting eyes are disposed on the welding bench.

20. The battery extinguishing device according to claim 6, comprising a plurality of the battery extinguishing containers simultaneously connected to the reservoir via a plurality of the liquid extinguishing agent lines or configured to be alternately connected to the reservoir via the at least one liquid extinguishing agent line.

21. The method according to claim 1, wherein the welding is by way of a robotic laser welding arm.

22. The battery extinguishing device according to claim 9, wherein the valve is a flap valve or a sliding valve and is located proximate the battery extinguishing chamber.

23. The battery extinguishing device according to claim 11, wherein the valve is a flap valve or a sliding valve.
